(19) United States
(12) Patent Application Publication
(10) Pub. No.: US 2010/0131865 A1
(43) Pub. Date: May 27, 2010

(54) Method and system for providing a multi-mode interactive experience

(75) Inventors: Jonathan Michael Ackley, Glendale, CA (US); Christopher J. Purvis, La Crescenta, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., Burbank, CA (US)

(21) Appl. No.: 12/313,867

(22) Filed: Nov. 24, 2008

(51) Int. Cl. G06F 3/048

(52) U.S. Cl. 715/757

(57) ABSTRACT

Disclosed are methods and systems for providing a multi-mode interactive experience. In one embodiment, a method comprises hosting a virtual environment corresponding to a real-life simulation environment, on a multi-mode interactive experience server, and networking the server and a venue management system configured to control events occurring in the real-life simulation environment. The networking enables a user to interact with the multi-mode interactive experience in a real-life simulation mode or in a virtual mode. The method further comprises associating a personalized version of the multi-mode interactive experience with an identification code assigned to the user, updating the personalized version of the multi-mode interactive experience according to events occurring in the real-life simulation mode and events occurring in the virtual mode of the multi-mode interactive experience, and providing the updated personalized version of the multi-mode interactive experience in one of the real-life simulation mode or the virtual mode.

### BACKGROUND OF THE INVENTION

1. Field of the Invention

The present invention relates to computer-enhanced entertainment. More particularly, the present invention relates to personalizing a computer mediated entertainment experience.

2. Background Art

The enduring popularity of theme parks, such as Disneyland in Anaheim, Calif., or Disney World, in Orlando, Fla., with visitors from around the world is testimony to the effectiveness with which those venues have captured a collective imagination and rendered it as simulated reality. Their very success in identifying themes that are attractive across a broad swath of the population highlights one of the challenges faced by an entertainment destination seeking to attract on-site visitors. Simply stated, leisure and entertainment destinations such as theme parks and destination resort properties are faced with the challenge of offering on-site experiences exploring themes and having features that are desirable to a wide general population, while at the same time being personally appealing to individual prospective visitors to the locale.

One approach with which theme parks, for example, have responded to this challenge in the past, is by diversifying the selection of attractions available to visitors and enhancing the realism of those attractions by implementing them as real-life simulations. By offering a variety of attractions of different types, and even among attractions of a similar type, presenting those experiences through a variety of themes, a broad spectrum of entertainment preferences may be catered to. For example, a single theme park may offer roller coaster ride type real-life simulations and water ride type real-life simulations, as well as other distinctive types of attractions, in an effort to accommodate a variety of aesthetic sensibilities. Furthermore, within a particular type of attraction, for example a roller coaster type ride, the experience may be offered through a real-life simulation environment corresponding to a child's fantasy adventure, such as Mr. Toad's Wild Ride; presented with a traditional fairy tale real-life simulation environment, as in the Matterhorn bobsled ride; or be provided using a real-life simulation environment having a futuristic theme, like Space Mountain; all of which are offered as alternative roller coaster type attractions at the Disneyland theme park.

That the previously described approach to meeting a spectrum of entertainment preferences has historically been successful is evidenced by the continuing popularity of Disneyland and other theme parks as vacation destinations. However, the advent of programmable portable entertainment products and devices, and the almost limitless variety of entertainment options they offer, have raised public expectations regarding the level of personal selection and customizability available to an entertainment consumer. As visitors to theme parks and other entertainment destinations begin to apply some of these heightened expectations fed by the increasing ubiquity of personal entertainment devices, those locales may be forced to offer an ever greater variety of experiences in order to continue to provide the high level of entertainment satisfaction with which they have traditionally been identified.

A conventional strategy for meeting this new challenge is to increase the number and to continue to diversify the types of attractions available on-site. Due to cost and resource constraints, however, there is a practical limit to how many distinct real-life simulation environments a single entertainment destination can support. As a result, and in the face of greater consumer demand for individual choice, it may no longer suffice for an entertainment destination to offer a universal on-site experience to be commonly shared by all visitors, no matter how artfully selected or designed that common experience may be. Consequently, in order to continue to provide the public with a high level of entertainment satisfaction, entertainment destinations such as theme parks may be compelled to find a way to provide a variety of distinct and customizable experiences from a single on-site attraction.

Accordingly, there is a need to overcome the drawbacks and deficiencies in the art by providing a solution enabling a user, such as a visitor to an entertainment destination, to enjoy a personalized experience when interacting with a real-life simulation environment provided on-site. Moreover, it is desirable that the solution enable the user to extend the personalized interactive experience to activities outside the venue supporting the real-life simulation environment by additionally empowering the user to access and interact with the personalized experience in a virtual environment.

### SUMMARY OF THE INVENTION

There are provided methods and systems for providing a multi-mode interactive experience, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of a system for providing a multi-mode interactive experience, according to one embodiment of the present invention;

FIG. 2 shows a more detailed embodiment of a system for providing a multi-mode interactive experience, focusing on system elements supporting interaction in a real-life simulation mode, according to one embodiment of the present invention;

FIG. 3 shows a more detailed embodiment of a system for providing a multi-mode interactive experience, focusing on interactivity in a virtual mode, according to one embodiment of the present invention; and

FIG. 4 is a flowchart presenting a method for providing a multi-mode interactive experience, according to one embodiment of the present invention.

### DETAILED DESCRIPTION OF THE INVENTION

The present application is directed to a method and system for providing a multi-mode interactive experience. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

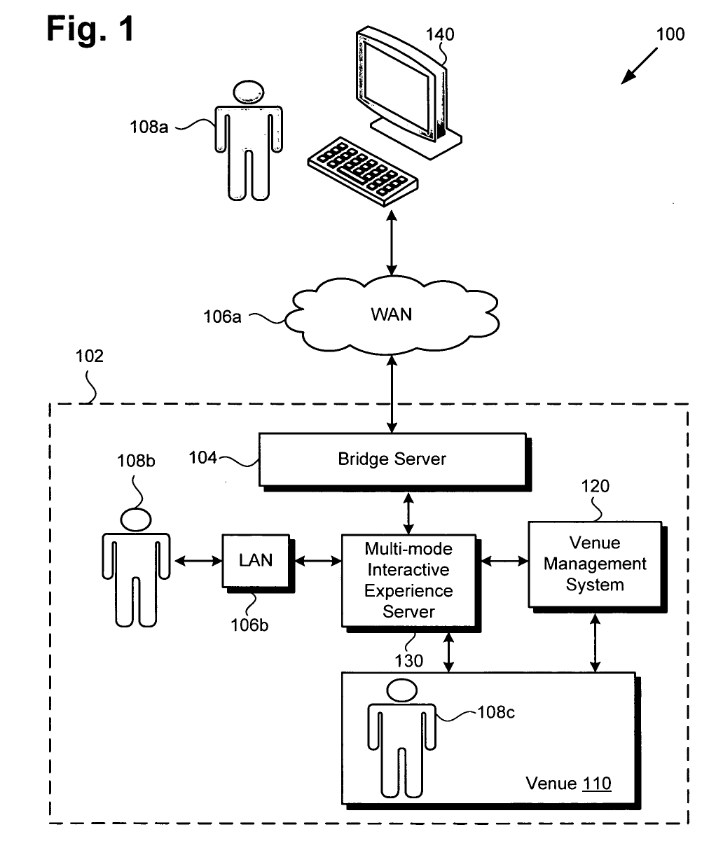

FIG. 1 is a diagram of a system for providing a multi-mode interactive experience, according to one embodiment of the present invention. In the embodiment of FIG. 1, multi-mode interaction environment 100 shows multi-mode interactive experience server 130 located in entertainment destination 102, which may be a theme park, or destination resort, for example. Multi-mode interactive experience server 130 is shown to be interactively communicating with client computer 140, via wide area network (WAN) 106a and bridge server 104. As may be seen from FIG. 1, entertainment destination 102 encompasses venue 110, venue management system 120, and local area network (LAN) 106b, in addition to multi-mode interactive experience server 130 and bridge server 104.

Also shown in FIG. 1 is a user, who is shown in triplicate as alternative incarnations of a single user as users 108a, 108b, or 108c, to indicate some of the various ways in which a user may interact with the system of FIG. 1. For example, as one possible interaction scenario, user 108a may utilize client computer 140 to interact with a multi-mode interactive experience provided by system 100 in a virtual mode over WAN 106a. Interaction in a virtual mode may represent interaction with a virtual environment hosted by multi-mode interactive experience server 130, produced so as to correspond to a real-life simulation environment provided by venue 110. As an alternative means of accessing the virtual environment corresponding to the real-life simulation environment provided by venue 110, user 108b may utilize LAN 106b to interact with the multi-mode interactive experience in the virtual mode.

As another alternative, user 108c may enter venue 110 and interact with the multi-mode interactive experience in a real-life simulation mode by participating in the real-life simulation environment provided there. As used in the present application, “virtual mode” refers to interaction between a user not present within venue 110, i.e., user 108a or 108b, and includes only virtual events occurring in the virtual environment corresponding to the real-life simulation environment of venue 110. By contrast, “real-life simulation mode” refers to interaction between a user participating in the real-life simulation of venue 110, i.e., user 108c, and may include both real events occurring in venue 110 and virtual events produced on multi-mode experience server 130.

For ease of visualization, let us continue the present description of FIG. 1 under the premise that entertainment destination 102 is a theme park, that venue 1 10 is a theme park attraction comprising the real-life simulation environment, and that multi-mode interactive experience server 130 is configured to produce and host the virtual environment corresponding to the real-life simulation environment provided by venue 110. More specifically, let us assume that the real life simulation environment provided by venue 110 includes a roller coaster type adventure ride/shooting game configured to simulate a space combat sequence, controlled by venue management system 120, and that the virtual environment hosted by multi-mode interactive experience server 130 is a computer virtual replication of the space combat sequence.

In the embodiment of FIG. 1, multi-mode interactive experience server is configured to associate a personalized version of the multi-mode interactive experience with the user, for example through provision of an identification code assigned to the user during a login/registration process by users 108a or 108b, or through entry or scanning of such a code into a peripheral device provided by entertainment destination 102, for example. Multi-mode interactive experience server 130 is further configured to update the personalized version of the multi-mode interactive experience according to events occurring during interactions in the real-life simulation mode, which may include both real events and virtual events, and to events occurring in the virtual mode, which typically include only virtual events.

As a result, the personalized multi-mode interactive experience is updatable according to the actions of the user, and may be both cumulative and progressive, enabling the user to carryover accumulated scores and/or enhanced powers from one user session to the next, whether user sessions occur in the virtual mode or in the real-life simulation mode. In some embodiments, special incentives may be provided to encourage the user to interact with their personalized multi-mode interaction experience in-park in the real-life simulation mode, so as to encourage theme park attendance, for example. Incentives may take the form of bonus points, special weapons or equipment, or access to higher levels of user authority over customizable features of the multi-mode interactive experience, not available through interaction in the virtual mode alone.

Communications from WAN 106a, LAN 106b, venue 110, and venue management system 120, may be networked through multi-mode interactive experience server 130 to allow the user, as user 108a or 108b, to interact with the virtual environment in the virtual mode, or to interact with the virtual environment and/or the real-life simulation environment in the real-life simulation mode as user 108c. Thus, as shown in FIG. 1, user 108c may participate in the real-life simulation environment provided by venue 110, in which case, multi-mode interactive experience server 130 may provide user 108c with their personalized multi-mode interactive experience in the real-life simulation mode.

Alternatively, and as also shown in FIG. 1, user 108a, who is outside of the confines of entertainment destination 102, is nevertheless able to access multi-mode interactive experience server 130, and to be provided with their personalized version of the multi-mode interactive experience in the virtual mode, through client computer 140 and WAN 106a, which in the present embodiment may correspond to the Internet, for example. It is noted that although in the embodiment of FIG. 1, client computer 140 is shown as a personal computer (PC), in other embodiments client computer 140 may comprise a mobile communication device or system, such as a tablet computer, mobile telephone, personal digital assistant (PDA), gaming console, or digital media player, for example.

As yet another alternative shown in FIG. 1, user 108b may be present in entertainment destination 102, but for any of a variety of reasons elect to access multi-mode interactive experience server 130 and be provided with their personalized version of the multi-mode interactive experience in the virtual mode, perhaps because of a long wait time associated with use of the real-life simulation environment provided by venue 110. User 108b, located within the theme park, may communicate with multi-mode interactive experience server 130 through LAN 106b, by means of a communication interface device (not shown in FIG. 1), such as a mobile communication device, as described with reference to client computer 140, or a network terminal provided by entertainment destination 102, for example.

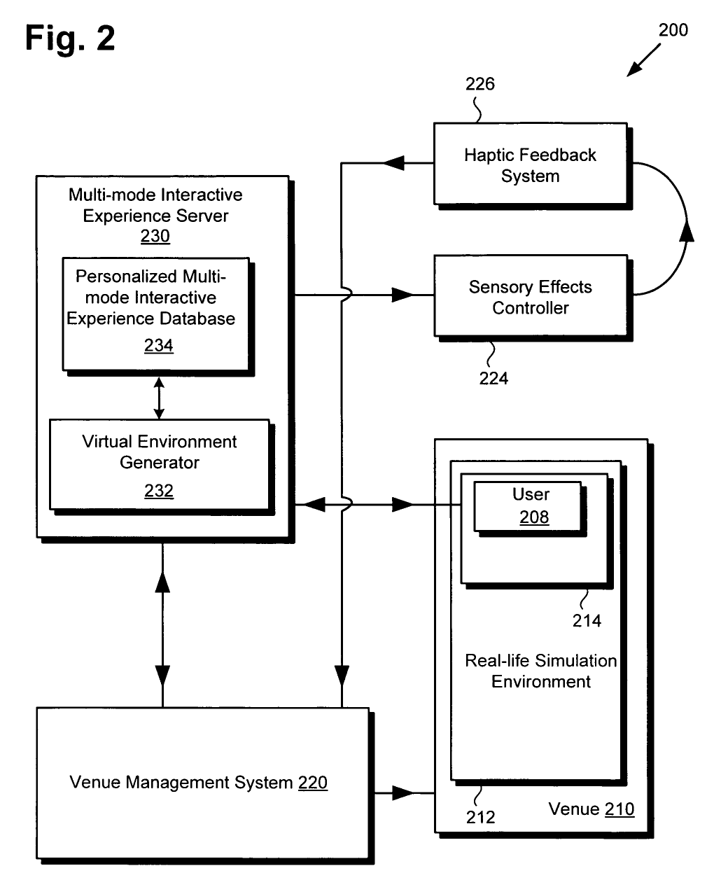

Moving now to FIG. 2, FIG. 2 shows a more detailed embodiment of a system for providing a multi-mode interactive experience, focusing on system elements supporting interaction in a real-life simulation mode, according to one embodiment of the present invention. According to the embodiment of FIG. 2, system 200 comprises venue 210, venue management system 220, multi-mode interactive experience server 230, and user 208, corresponding respectively to venue 110, venue management system 120, multi-mode interactive experience server 130, and user 108c, in FIG. 1. In addition, FIG. 2 shows sensory effects controller 224 and haptic feedback system 226, which are not represented in the system of FIG. 1.

As shown in FIG. 2, venue 210 includes vehicle 214, by means of which user 208 may participate in real-life simulation environment 212, for example as a passenger in vehicle 214. Real-life simulation environment 212 is interactively linked to multi-mode interactive experience server 230, which, additionally, hosts virtual environment generator 232 and personalized multi-mode interactive experience database 234. The arrows shown in FIG. 2 are provided to indicate the direction of data flow for the embodiment of system 200, and are merely illustrative. Other embodiments may include fewer or more constituent elements, may consolidate or further distribute the elements shown in FIG. 2, and/or may be implemented using other configurations for data flow.

Venue 210, which may comprise a theme park attraction such as a roller coaster ride or other type of adventure ride, for example, includes real-life simulation environment 212, through which vehicle 214 can move. Vehicle 214, which in the present embodiment may comprise a theme park ride vehicle, such as, for example, a roller coaster car or carriage, may be designed to transport user 208 through real-life simulation environment 212, along a predetermined path. Vehicle 214 may be configured to move through real-life simulation environment 212 of venue 210, under the control of venue management system 220. As shown in the embodiment of FIG. 2, venue management system 220 is interactively linked to multi-mode interactive experience server 230.

Multi-mode interactive experience server 230 is shown to include personalized multi-mode interactive experience database 234, which is provided to store the personalized multi-mode interactive experience associated with user 208. In addition, in FIG. 2, multi-mode interactive server 230 includes virtual environment generator 232, configured to produce virtual events, which in some embodiments may be synchronized to real events occurring in venue 210. Virtual events may correspond to real events such as the movement of vehicle 214 through real-life simulation environment 212, and/or interactions between user 208 and venue 210, as recorded by multi-mode interactive experience server 230, for example. In some embodiments, in addition to virtual events in the virtual environment being synchronized with real events in real-life simulation environment 212, real events in real-life simulation environment 212 may be synchronized to virtual events in the virtual environment produced by virtual environment generator 232.

According to the frame of reference of system 200, multi-mode interactive experience server 230 enables user 208 to interact with a personalized version of a multi-mode interactive experience in a real-life simulation mode. Multi-mode interactive experience server 230 is configured to associate a personalized version of the multi-mode interactive experience with an identification code assigned to user 208, update the personalized version of the multi-mode interactive experience according to events occurring in the real-life simulation mode, as well as events occurring earlier or later in the virtual mode of the multi-mode interactive experience, and provide the updated personalized version of the multi-mode interactive experience to user 208 in the real-life simulation mode.

In one embodiment, multi-mode interactive experience server 230 may be configured to provide user 208 with an augmented sensory perspective comprising a selective blending of real events occurring in real-life simulation environment 212 and virtual events produced by virtual environment generator 232. In that embodiment, system 200 is capable of providing user 208 with an augmented reality experience linked to their transport through real-life simulation environment 212.

According to the embodiment of FIG. 2, system 200 includes sensory effects controller 224 and haptic feedback system 226. As shown in system 200, sensory effects controller 224 and haptic feedback system 226 receive input from multi-mode interactive experience server 230, and are in communication with venue management system 220. Sensory effects controller 224, under the direction of multi-mode interactive experience server 230, may be configured to produce audio and/or visual effects, generate odors or aromas, and provide special effects such as wind, rain, fog, and so forth, in real-life simulation environment 212. Sensory effects controller 224 may provide those effects to produce real events in real-life simulation environment 212 corresponding to virtual events produced by virtual environment generator 232, as well as to produce real events corresponding to interaction of user 208 with venue 210, for example.

Haptic feedback system 226 may be configured to produce tactile effects in order to generate real events in real-life simulation environment 212 simulating the consequences of virtual events occurring in the virtual environment produced by virtual environment generator 232. The tactile effects produced by haptic feedback system 226 may result, for example, from displacement, rotation, tipping, and/or jostling of vehicle 214, to simulate the consequences of virtual events produced by virtual environment generator 232. Although in the embodiment of FIG. 2 sensory effects controller 224 and haptic feedback system 226 are shown as distinct elements of system 200, in other embodiments the functionality provided by sensory effects controller 224 and haptic feedback system 226 may be provided by a single control system. In still other embodiments, sensory effects controller 224 and haptic feedback system 226 may be subsumed within venue management system 220.

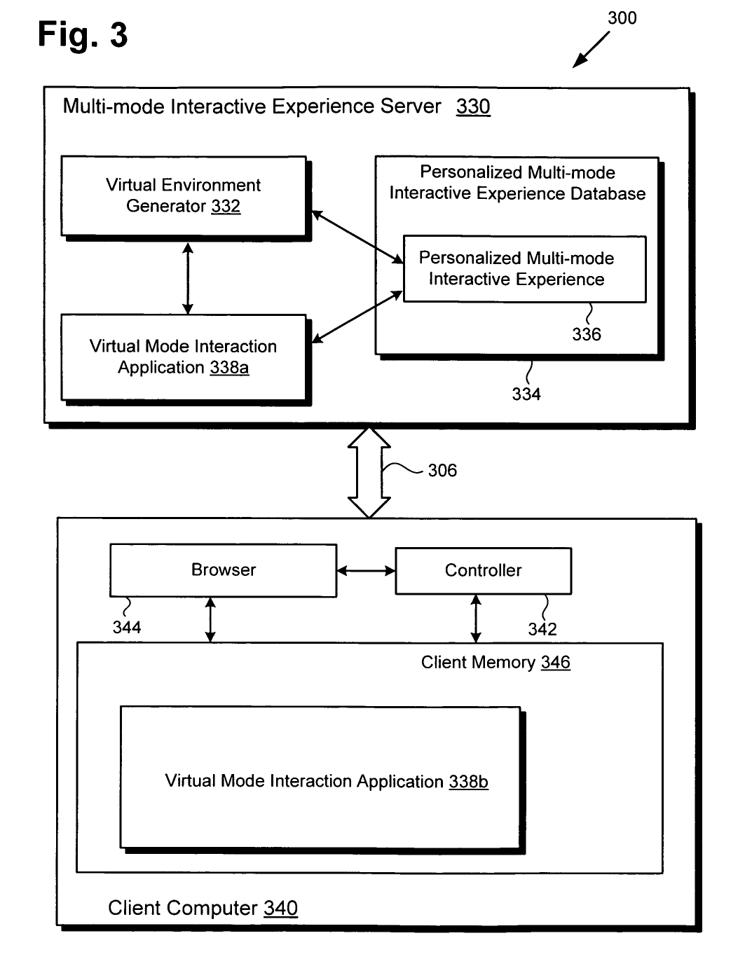

Turning now to FIG. 3, FIG. 3 shows a more detailed embodiment of a system for providing a multi-mode interactive experience, focusing on interactivity in a virtual mode, according to one embodiment of the present invention. Subsystem 300, in FIG. 3, comprises multi-mode interactive experience server 330 in communication with client computer 340 via communication link 306, corresponding respectively to multi-mode interactive experience server 130 in communication with client computer 140 via WAN 106a, in FIG. 1. It is noted that communication link 306, in FIG. 3, may also correspond to LAN 106b linking remote user 108b and multi-mode interactive experience server 130, in FIG. 1.

Multi-mode interactive experience server 330, in FIG. 3, is shown to comprise virtual environment generator 332 and personalized multi-mode interactive experience database 334, corresponding respectively to virtual environment generator 232 and personalized multi-mode interactive experience database 234, in FIG. 2. Also present on multi-mode interactive experience server 330 are personalized multi-mode interactive experience 336 and virtual mode interaction application 338a, which have not been represented in previous figures. Furthermore, client computer 340 is shown to comprise controller 342, browser 344, and client memory 346. Also shown in FIG. 3 is virtual mode interaction application 338b.

As shown in FIG. 3, virtual mode interaction application 338a may be accessed through communication link 306, corresponding to WAN 106a, in FIG. 1. In that instance, virtual mode interaction application 338a may comprise a web application, accessible over a packet network such as the Internet. In that embodiment, virtual mode interaction application 338a may be configured to execute as a server based application on multi-mode interactive experience server 330, for example, to enable a user, such as user 108a, in FIG. 1, to engage the multi-mode interactive experience hosted on multi-mode interactive experience server 130 in the virtual mode. Alternatively, virtual mode interaction application 338a may reside on a server supporting a LAN, such as LAN 106b, or be included in another type of limited distribution network.

According to the embodiment of FIG. 3, however, client computer 340 receives virtual mode interaction application 338b as a download via communication link 306 from multi-mode interactive experience server 330. Once transferred, virtual mode interaction application 338b may be stored in client memory 346 and executed locally on client computer 340, as a desktop application, for example. Client computer 340 includes controller 342, which may be the central processing unit for client computer 340, for example, in which role controller 342 runs the client computer operating system, launches browser 344, and facilitates use of virtual mode interaction application 338b. Browser 344, under the control of controller 342, may execute virtual mode interaction application 338b to enable a user to access and interact with personalized virtual mode interactive experience 336 in the virtual mode.

According to the frame of reference of subsystem 300, multi-mode interactive experience server 330 enables a user of client computer 340 to interact with a personalized version of a multi-mode interactive experience in a virtual mode. Multi-mode interactive experience server 330 is configured to associate a personalized version of the multi-mode interactive experience with an identification code assigned to the user of client computer 340, update the personalized version of the multi-mode interactive experience according to events occurring in the virtual mode, as well as events occurring earlier or later in the real-life simulation mode of the multi-mode interactive experience, and provide the updated personalized version of the multi-mode interactive experience to the user of client computer 340 in the virtual mode.

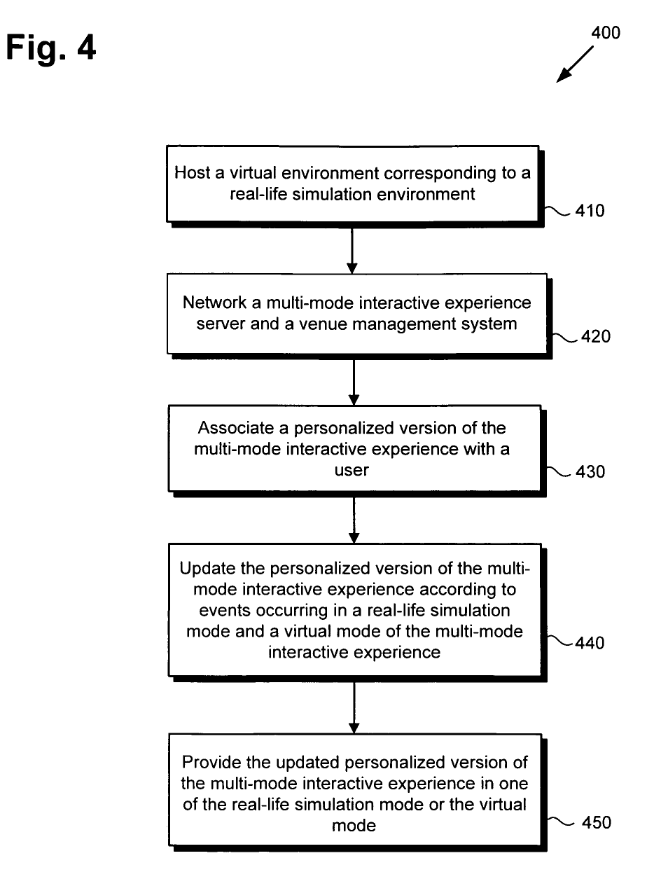

The systems of FIG. 1 through FIG. 3 will be further described with reference to FIG. 4, which presents a method for providing a multi-mode interactive experience, according to one embodiment of the present invention. Certain details and features have been left out of flowchart 400 that are apparent to a person of ordinary skill in the art. For example, a step may consist of one or more substeps or may involve specialized equipment or materials, as known in the art. While steps 410 through 450 indicated in flowchart 400 are sufficient to describe one embodiment of the present method, other embodiments may utilize steps different from those shown in flowchart 400, or may include more, or fewer steps.

Beginning with step 410 in FIG. 4 and referring to FIG. 2, step 410 of flowchart 400 comprises hosting a virtual environment corresponding to real-life simulation environment 212. Hosting the virtual environment, in step 410, may be performed by multi-mode interactive experience server 230. In the example of the roller coaster ride/shooting game presently under consideration, multi-mode interactive experience server 230 could be configured to host a computer virtual simulation of passage of vehicle 214 through real-life simulation environment 212. As a result of step 410, two complementary realities corresponding to passage of vehicle 214 through real-life simulation environment 212 are created. One reality, the physical reality of the roller coaster ride in venue 210, is created by the real events occurring during transport of the local user through venue 210. The second reality is a computer simulated version of the roller coaster ride/shooting game that is generated so as to substantially reproduce the ride experience in virtual form.

Continuing with step 420 of flowchart 400 and turning to FIG. 1, step 420 comprises networking multi-mode interactive experience server 130 and venue management system 120. Networking of communications may be performed by LAN 106b, for example, either alone, or in conjunction with WAN 106a. As a result, the user, as user 118c, can interact with the multi-mode experience in the real-life simulation environment provided by venue 110, in the real-life simulation mode. Alternatively, the user, as one of users 108a or 108b not present in venue 110, may nevertheless interact with the multi-mode interactive experience in the virtual environment corresponding to the real-life simulation environment, in the virtual mode.

Step 430 of flowchart 400 comprises associating a personalized version of the multi-mode interactive experience with the user. Association of the user with a personalized experience may be performed by multi-mode interactive experience server 130 in response to inputs provided remotely, i.e., by means of client computer 140 through a remote login or registration process, for example, in which user 108a inputs an identification code assigned to that user. As a result, user 108a may gain access to a personalized multi-mode interactive experience, such as personalized multi-mode interactive experience 336 in FIG. 3, in the virtual mode.

Alternatively, an in-venue user, such as user 108c, in FIG. 1, may be associated with their personalized multi-mode interactive experience stored on multi-mode experience server 130, by providing an identification code as an input to multi-mode interactive experience server 130. In-venue input of an identification code assigned to the user may be by means of a keypad, provided as a peripheral device to multi-mode experience server 130, in venue 110, or by means of a wireless identification system, for example, such as a radio-frequency identification (RFID) bracelet or tag, readable by a scanner provided at venue 110. In other embodiments, in-venue input of the identification code assigned to the user may be accomplished using any of several different ways, including barcode scanning, bio-metric recognition, or by means of a magnetic card reader, for example.

Flowchart 400 continues with step 440, comprising updating the personalized version of the multi-mode interactive experience according to events occurring in the real-life simulation mode and events occurring in the virtual mode of the multi-mode interactive experience. Referring once again to FIG. 2, updating of the personalized version of the multi-mode interactive experience may be performed by multi-mode interactive experience server 230 in response to virtual events and/or real events resulting from interaction of the user with real-life simulation environment 212. In addition, updating of the personalized version of the multi-mode experience may occur in response to remote interaction of the user with the virtual environment corresponding to real-life simulation environment 212, in which case only virtual events typically occur.

As a result of step 440, a personalized multi-mode interactive experience may be made both cumulative and progressive, as discussed previously in reference to FIG. 1. Consequently, the user may carryover accumulated scores and/or enhanced powers from one user session to the next, whether user sessions occur remotely in the virtual mode or locally to the venue, in the real-life simulation mode. As previously mentioned, in some embodiments, special incentives may be provided to encourage the user to interact with their personalized multi-mode interaction experience in-venue in the real-life simulation mode, so as to encourage theme park attendance, for example. Incentives may take the form of bonus points, special weapons or equipment, or access to higher levels of user authority over customizable features of the multi-mode interactive experience, not available through interaction in the virtual mode alone.

Moving on to step 450 of flowchart 400, step 450 comprises providing the updated personalized version of the multi-mode interactive experience in one of the real-life simulation mode or the virtual mode. Step 450 may be performed by multi-mode interactive experience server 230, in FIG. 2, in response to data received from the user indicating their mode of access, either local, within venue 210, or remote, via a communication device outside of venue 210.

Although not included in the method of flowchart 400, in some embodiments, a method for providing a multi-mode interactive experience may comprise producing the virtual environment corresponding to the real life simulation environment, for example, as shown in FIG. 2 by virtual environment generator 232 residing on multi-mode interactive experience server 230. In some embodiments, moreover, the present method may include providing venue 210 including real-life simulation environment 212. In view of the specific example embodiment discussed previously, providing a venue including a real-life simulation environment may be seen to correspond to providing the physical setup for the roller coaster ride itself, i.e., track, roller coaster carriages, special effects generating equipment, and so forth.

In one embodiment, the method of flowchart 400 may further comprise synchronizing the real events and the virtual events so that the real events can be represented in the virtual environment and the virtual events can be represented in the real-life simulation environment. Synchronizing the real-life simulation environment and virtual environment enables a substantially seamless overlay of the virtual and real environments provided according to the present method. As a result, the user may interact with the virtual environment corresponding to the real-life simulation environment, in the real-life simulation mode, and produce events in both environments in real time. For instance, video screens and speakers bordering the space ride could produce images and sounds corresponding to destruction of an enemy spacecraft as a result of a hit achieved by the user, either through interaction with the virtual environment, or through interaction with real features present in the real-life simulation environment.

In some embodiments, the real events and the virtual events may be selectively blended to provide the user with an augmented sensory perspective, thereby providing an augmented reality experience. An augmented sensory perspective may be produced by overlay of the virtual reality of the virtual environment and the real events occurring in real-life simulation environment of the venue. Moreover, in one embodiment, the method of flowchart 400 may further comprise utilizing a haptic feedback system, such as haptic feedback system 226 in FIG. 2, to generate real effects in real-life simulation environment 212 corresponding to virtual effects in the virtual environment. For example, destruction of an enemy spacecraft, in addition to being accompanied by audio and visual effects produced in real-life simulation environment 212, may be rendered even more realistic by recoil or jostling of vehicle 214 to simulate impact of the shock wave produced by the exploding spacecraft. Analogously, virtual hits by enemy spacecraft on vehicle 214 may be accompanied by displacements, rotations, tipping, and the like, produced by haptic feedback system 226.

Thus, the present application discloses a method and system for enabling a user, such as a visitor to a theme park or destination resort, to enjoy a personalized experience when interacting with a real-life simulation environment provided on-site. In addition, the disclosed method and system enable the user to extend the personalized interactive experience to activities outside the venue supporting the real-life simulation environment, by additionally empowering the user to access and interact with the personalized experience in a corresponding virtual environment. From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A method for providing a multi-mode interactive experience, the method comprising:
hosting a virtual environment on a multi-mode interactive experience server, the virtual environment corresponding to a real-life simulation environment;
networking the multi-mode interactive experience server and a venue management system configured to control events occurring in the real-life simulation environment, the networking enabling a user to interact with the multi-mode interactive experience in the real-life simulation environment in a real-life simulation mode or in the virtual environment in a virtual mode;
associating a personalized version of the multi-mode interactive experience with an identification code assigned to the user;
updating the personalized version of the multi-mode interactive experience according to events occurring in the real-life simulation mode and events occurring in the virtual mode of the multi-mode interactive experience; and
providing the updated personalized version of the multi-mode interactive experience in one of the real-life simulation mode or the virtual mode.

2. The method of claim 1, further comprising offering the user an incentive to interact with the multi-mode interactive experience in the real-life simulation mode.

3. The method of claim 1, wherein providing the multi-mode interactive experience in the virtual mode comprises enabling the user to access the multi-mode interactive experience over the Internet.

4. The method of claim 1, wherein providing the multi-mode interactive experience in the virtual mode comprises enabling the user to access the multi-mode interactive experience over a local area network (LAN).

5. The method of claim 1, wherein providing the multi-mode interactive experience in the real-life simulation mode comprises providing the user with an augmented reality experience.

6. The method of claim 1, further comprising producing the virtual environment corresponding to the real-life simulation environment.

7. The method of claim 1, further comprising providing a venue including the real-life simulation environment.

8. The method of claim 7, wherein the venue comprises a theme park attraction.

9. The method of claim 7, wherein the real-life simulation environment comprises a theme park ride.

10. The method of claim 7 wherein the venue is comprised by a destination resort.

11. A system for providing a multi-mode interactive experience, the system comprising:
a venue including a real-life simulation environment for implementation of the multi-mode interactive user experience in a real-life simulation mode;
a venue management system configured to control real events occurring within the real-life simulation environment;
a multi-mode interactive experience server interactively linked to the venue management system, the multi-mode interactive experience server configured to host a virtual environment corresponding to the real-life simulation environment; and
a communication network enabling a user to interact with the multi-mode interactive experience in the real-life simulation environment in the real-life simulation mode or in the virtual environment corresponding to the real-life simulation environment in a virtual mode;
the multi-mode interactive experience server further configured to associate a personalized version of the multi-mode interactive experience with an identification code assigned to the user, update the personalized version of the multi-mode interactive experience according to events occurring in the real-life simulation mode and events occurring in the virtual mode of the multi-mode interactive experience, and provide the updated personalized version of the multi-mode interactive experience in one of the real-life simulation mode or the virtual mode.

12. The system of claim 11, further configured to provide the user with an augmented reality experience in the real-life simulation mode.

13. The system of claim 11, wherein the communication network comprises a local area network (LAN).

14. The system of claim 11, wherein the communication network comprises a LAN supporting communication at a theme park.

15. The system of claim 11, wherein the communication network comprises a LAN supporting communication at a destination resort.

16. The system of claim 11, further comprising a bridge server configured to interface the multi-user experience server with a wide area network (WAN).

17. The system of claim 16, wherein the WAN comprises the Internet.

18. The system of claim 11, wherein the venue comprises a theme park attraction.

19. The system of claim 11, wherein the real-life simulation environment comprises a theme park ride.

20. The system of claim 11 wherein the venue is comprised by a destination resort.
